(19) United States
(12) Patent Application Publication
(10) Pub. No.: US 2016/0255148 A1
(43) Pub. Date: Sep. 1, 2016

(54) ELECTRONIC DEVICES AND METHODS FOR PROCESSING HARDWARE OR SOFTWARE SERVICE REQUESTS BETWEEN INTERCONNECTED ELECTRONIC DEVICES

(71) Applicant: MediaTek Singapore Pte. Ltd., Singapore (SG)

(72) Inventors: Yanni HUANG, Beijing (CN); Jen-Chieh LO, Zhushan Township (TW); Shu-Hsin CHANG, Hsinchu City (TW); YAJUN LI, Beijing (CN); Meng LI, Beijing (CN); Dan LUO, Hunan Province (CN)

(21) Appl. No.: 15/054,539

(22) Filed: Feb. 26, 2016

(30) Foreign Application Priority Data
Feb. 28, 2015 (CN) 201510091566.4
Jan. 21, 2016 (CN) 201610041909.0

(51) Int. Cl. H04L 29/08; G06F 9/455; H04L 29/06

(52) U.S. Cl. CPC H04L 67/1093; H04L 69/08; G06F 9/455

(57) ABSTRACT

A method for processing hardware or software service requests, applied in a first electronic device, including: receiving a first hardware or software service request; determining whether there is a need to use hardware or software of a second electronic device to process the first hardware or software service request; transmitting the first hardware or software service request to the second electronic device when there is a need to use the hardware or software of the second electronic device; receiving a first response message from the second electronic device, wherein the first response message indicates that the hardware or software of the second electronic device provides the first hardware or software service; and providing the first hardware or software service according to the first response message.

### CROSS REFERENCE TO RELATED APPLICATIONS

This Application claims priority of China Patent Application No. 201510091566.4 filed on Feb. 28, 2015 and China Patent Application No. 201610041909.0 filed on Jan. 21, 2016, the entirety of which are incorporated by reference herein.

### BACKGROUND OF THE INVENTION

1. Field of the Invention

The present invention relates to communication between intelligent electronic devices, and in particularly relates to methods for sharing the service provided by hardware/software between intelligent electronic devices.

2. Description of the Related Art

In modern society, smartphones, intelligent devices, and home automation are becoming more common and are developing rapidly, and the combination of a variety of intelligent devices has become a trend. On the current consumer market, service may provides wireless interconnection between intelligent devices, like through the cloud, or an account, or through the extensive use of P2P direct connection etc., which is quite complicated. The technical difficulty involved in achieving wireless interconnection through the cloud or an account is quite high. The wireless interconnection through P2P direct connection achieves only limited functionality, and with a limited physical range. Furthermore, the techniques that are available on the market are incapable of creating interconnections between devices and the mutual usage of software, hardware, and service between devices. For a better user experience, how to achieve this capability between electronic devices in a more convenient way and for more extensive applications is a subject worthy of study.

CrossMount™ (referring to U.S. patent application Ser. No. 14/943,363 and U.S. patent application Ser. No. 14/948,040) was recently developed for a mounting connection between intelligent electronic devices. Network connection is used in CrossMount™ and, through the network connection, hardware devices (e.g. a camera, a microphone) and software applications on different devices are mounted to each other. One device may regard itself as being possessed of hardware (e.g. a camera, a microphone) of a remote device. Through CrossMount™, the hardware on the different devices is seamlessly connected to each other. The existing commercial software applications, therefore, are no longer subject to hardware limitations.

FIG. 1 illustrates the logic architecture of a first electronic device 100 and a second electronic device 102 with a mounting connection according to CrossMount™. The first electronic device 100 is a hardware/software service-requesting device. The second electronic device 102 is a hardware/software service provider. The first electronic device 100 comprises a processing module 120, a connection module 130, and a virtualization module 140. The processing module 120 is coupled to the connection module 130 and the virtualization module 140. The connection module 130 establishes a connection between the first electronic device 100 and another device (e.g. the second electronic device 102) through a network connection. After the connection is established, the virtualization module 140 receives hardware/software information from the second electronic device 102. Based on the hardware/software information of the second electronic device 102, the virtualization module 140 virtualizes one or more modules of hardware/software (e.g. a camera) to support various kinds of service on the first electronic device 100.

The second electronic device 102 comprises a processing module 122, a connection module 132, a virtualization module 142, and a hardware/software module 152. The processing module 122 is coupled to the connection module 132, the virtualization module 142, and the hardware module 152 for information and data processing and control. Here, the hardware module 152 include not only the hardware components, but the software function supported by the hardware components. The connection module 132 establishes a connection between the second electronic device 102 and another device (e.g. the first electronic device 100) through a network connection. After the connection is established, the virtualization module 142 outputs hardware/software information of the second electronic device 102 to the first electronic device 100 and receives hardware/software requests from the first electronic device 100 to drive the hardware module 152 to provide service for the first electronic device 100.

FIG. 2 is a flowchart depicting communication between the first electronic device 100 and the second electronic device 102 with mounting connection according to CrossMount™. In step S202, the first electronic device 100 searches for other devices and obtains the second electronic device 102 according to a proposal such as UpnP (Universal Plug and Play) proposal. After the connection is established, the virtualization module 140 of the first electronic device 100 may receive some information describing hardware/software of the second electronic device 102 (step S204). In step S206, the virtualization module 140 virtualizes the hardware/software based on the received information in the first electronic device 100. In step S208, the virtualization module 140 informs the processing module 120 of the virtual installation of new hardware/software. After the communication process mentioned above is finished, the first electronic device 100 may directly access the connected hardware/software that has been virtualized as if it were integrated within the first electronic device 100, and it may use the connected hardware/software to carry out associated service applications.

According to the aforementioned techniques, electronic devices expanding the device hardware/software capability by the CrossMount™ mounting connection does not need a directly connected hardware entity. Accordingly, how to share the hardware, software and service between interconnected devices in a more convenient and efficient way to provide a better user experience is indeed a worthy subject of study.

### BRIEF SUMMARY OF THE INVENTION

In view of this, methods for processing hardware or software service requests are provided in the present invention.

A method for processing hardware or software service requests, applied in a first electronic device includes: receiving a first hardware or software service request; determining whether there is a need to use the hardware or software of a second electronic device to process the first hardware or software service request; transmitting the first hardware or software service request to the second electronic device when there is a need to use the hardware or software of the second electronic device; receiving a first response message from the second electronic device, wherein the first response message indicates that the hardware or software of the second electronic device provides the first hardware or software service; and, according to the first response message, providing the first hardware or software service. The first electronic device and the second electronic device are connected through network interconnection. The first electronic device receives information about the hardware or software of the second electronic device to virtualize the hardware or software of the second electronic device in the first electronic device.

A method for processing hardware or software service requests, applied in a first electronic device, includes: receiving a first hardware or software service request from a second electronic device; providing the first hardware or software service and generating a first response message to indicate that hardware or software of the first electronic device provides the first hardware or software service; and transmitting the first response message to the second electronic device, wherein: the first electronic device and the second electronic device are connected to each other through network interconnection; and the second electronic device receives information about the hardware or software of the first electronic device to virtualize the hardware or software of the first electronic device in the second electronic device.

An electronic device applied for requesting hardware or software service, comprising: a connection module, establishing a connection to a second electronic device through network interconnection; a processing module coupled to the connection module, wherein when the electronic device receives a first hardware or software service request, processing module, determining whether there is a need to use hardware or software of a second electronic device to process the first hardware or software service request; an virtualization module, coupled to the processing module, receiving information about the hardware or software of the second electronic device to virtualize the hardware or software of the second electronic device in the first electronic device, transmitting the first hardware or software service request to the second electronic device when there is a need to use the hardware or software of the second electronic device; and receiving a first response message from the second electronic device, wherein the first response message indicates that the hardware or software of the second electronic device provides the first hardware or software service; and wherein the processing module further provides the first hardware or software service according to the first response message.

An electronic device applied for providing hardware or software service, comprising: a connection module, establishing a connection to a second electronic device through network interconnection; an virtualization module, receiving a first hardware or software service request from the second electronic device; a service module, including hardware or software to provide the first hardware or software service; and a processing module coupled to the virtualization module, wherein according to the first hardware or software service request, the processing module controls the service module to provide the first hardware or software service and generates a first response message to indicate that the hardware or software of the first electronic device provides the first hardware or software service, wherein the virtualization module transmits the first response message to the second electronic device

### BRIEF DESCRIPTION OF THE DRAWINGS

The present invention can be more fully understood by reading the subsequent detailed description and examples with references made to the accompanying drawings, wherein:

FIG. 1 illustrates logic architecture of a first electronic device 100 and a second electronic device 102 with mounting connection according to CrossMount™;

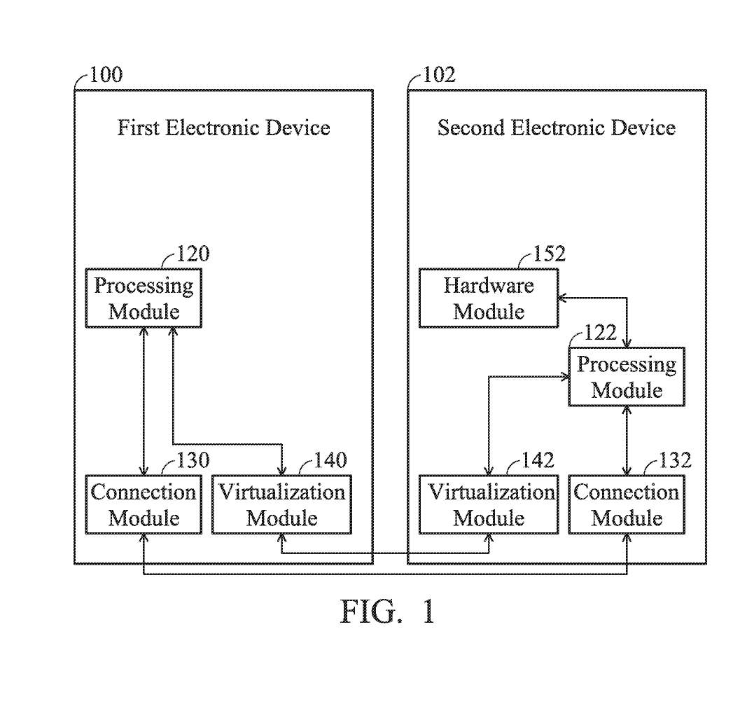

FIG. 2 is a flowchart depicting communication between the first electronic device 100 and the second electronic device 102 with mounting connection according to CrossMount™;

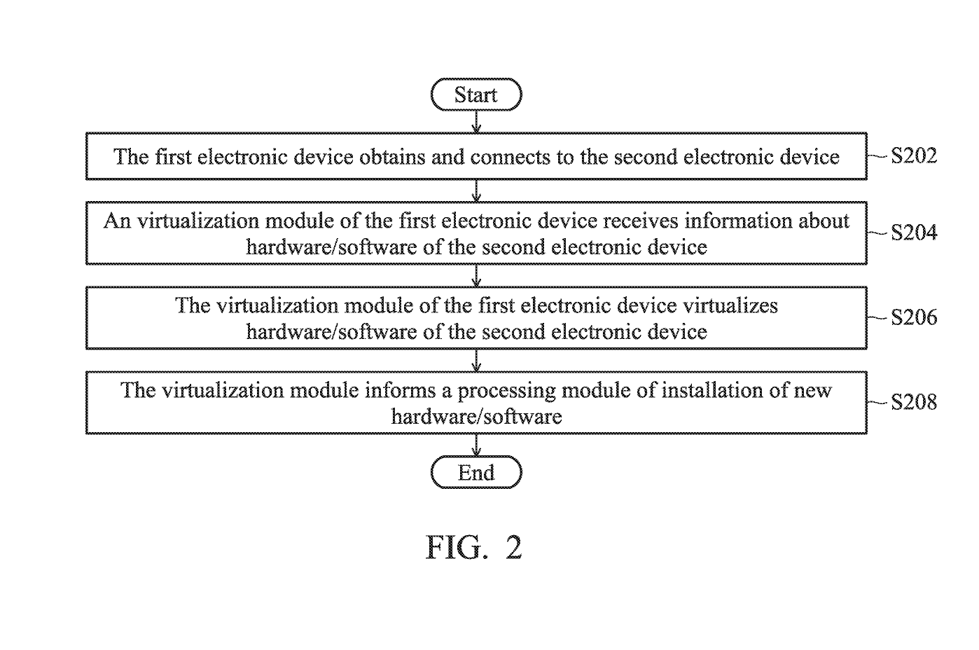

FIG. 3 depicts a basic architecture between a first electronic device 300 and a second electronic device 302 in accordance with an exemplary embodiment of the disclosure;

FIG. 4 is a flowchart depicting a method for requesting hardware/software service, which is applied in the first electronic device 300 of FIG. 3 according to an exemplary embodiment of the disclosure;

FIG. 5 is a flowchart depicting a method for providing hardware/software service, which is applied in the second electronic device 302 of FIG. 3;

FIG. 6 depicts system architecture in which multiple electronic devices request hardware/software service of one electronic device;

FIG. 7 is a flowchart depicting a method for requesting hardware/software service according to an exemplary embodiment of the disclosure, which is applied in the first electronic device 600 of FIG. 6;

FIG. 8 illustrates a system architecture in which one electronic device provides hardware/software service to multiple electronic devices in accordance with an exemplary embodiment of the disclosure;

FIG. 9 is a flowchart depicting a method for providing hardware/software service in accordance with an exemplary embodiment of the disclosure, which is applied in a first electronic device 800; and

FIG. 10 illustrates system architecture of an exemplary embodiment of the disclosure.

### DETAILED DESCRIPTION OF THE INVENTION

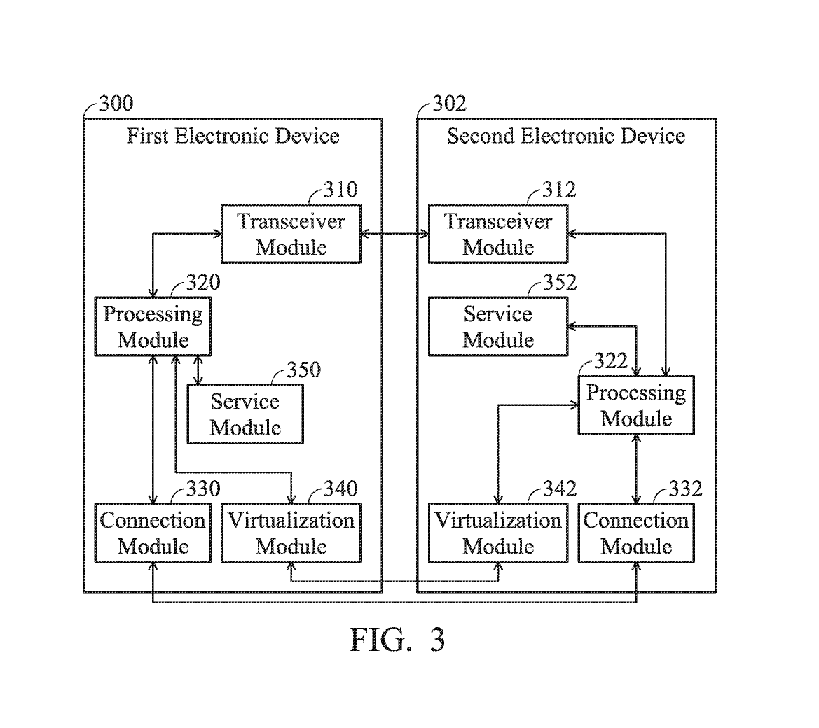

FIG. 3 depicts a basic architecture between a first electronic device 300 and a second electronic device 302 in accordance with an exemplary embodiment of the disclosure. The first electronic device 300 and the second electronic device 302 may be a smartphone, a tablet PC, an intelligent TV, an audio set, and so on, which may be connected to each other through network interconnection (e.g., WiFi or Bluetooth), touch screen sensing (e.g. HotKnot) and so on. Based on CrossMount™ technology, after a connection is established, an virtualization module 342 of the second electronic device 302 reads its local hardware/software information and then transmits the information to an virtualization module 340 of the first electronic device 300. Based on the received information, the virtualization module 340 of the first electronic device 300 virtualizes the corresponding hardware/software of the second electronic device 302. Thus, the operating system in the upper layer of the first electronic device 300 recognizes the imitated hardware/software as newly mounted hardware/software. After such a setting, the first electronic device 300 can access the imitated hardware/software.

As shown in FIG. 3, the first electronic device 300 includes a transceiver module 310, a processing module 320, a connection module 330, an virtualization module 340 and a service module 350. On the other side, the second electronic device 302 includes a transceiver module 312, a processing module 322, a connection module 332, an virtualization module 342 and a service module 352. It should be noted that the modules of the first electronic device 300 and the second electronic device 302 shown in FIG. 3 are only for the purpose of the description of the exemplary embodiments of the disclosure, and are not intended to limit the present invention. The first electronic device 300 and the second electronic device 302 may further comprise other hardware or software modules which are not shown in the figure.

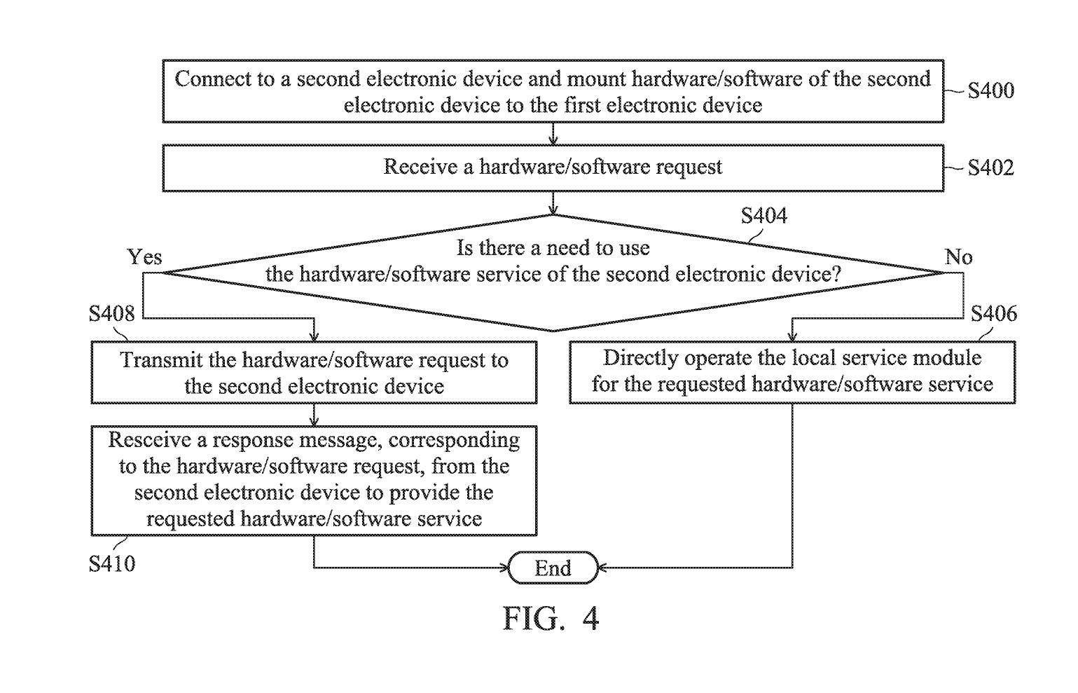

FIG. 4 is a flowchart depicting a method for requesting hardware/software service, which is applied in the first electronic device 300 of FIG. 3 according to an exemplary embodiment of the disclosure. In step 5400, a connection to the second electronic device 302 is established by the connection module 330 through network connection (e.g. CrossMount™) to mount the hardware module or the software service of the second electronic device 302 onto the first electronic device 300. In step 5402, the first electronic device 300 receives a hardware/software service request from an electronic device (e.g. the second electronic device 302 or any other electronic device). In step 5404, the processing module 320 determines whether there is a need to use the hardware or software of the second electronic device 302. When the processing module 320 determines that the service module 350 includes hardware/software capable of providing the requested service, there is no need to call the hardware/software service module of the second electronic device 302 and the processing module 320 directly controls the service module 350 to run the requested hardware/software (in step S406). Otherwise, when the first electronic device 300 does not include the requested hardware/software, or the requested hardware/software is not available, there is a need to use the second electronic device 302, and the hardware/software service request is then transmitted to the second electronic device 302 through the virtualization modules 340 and 342 to request the hardware/software modules of the second electronic device 302 to provide the first electronic device 302 with the requested hardware/software service (in step S408). When it is a software service that needs to be provided by the second electronic device 302, the data associated with the software service is communicated between the first and the second electronic devices 300 and 302 through the transceiver modules 312 and 310. When it is a hardware function that needs to be provided by the second electronic device 302, the hardware request is conveyed through the virtualization modules 340 and 342. Then, the first electronic device 300 receives a response message from the service module 352 or the virtualization module 342 of the second electronic device 302, and the response message shows that the second electronic device 302 provides the requested hardware/software service (in step S410).

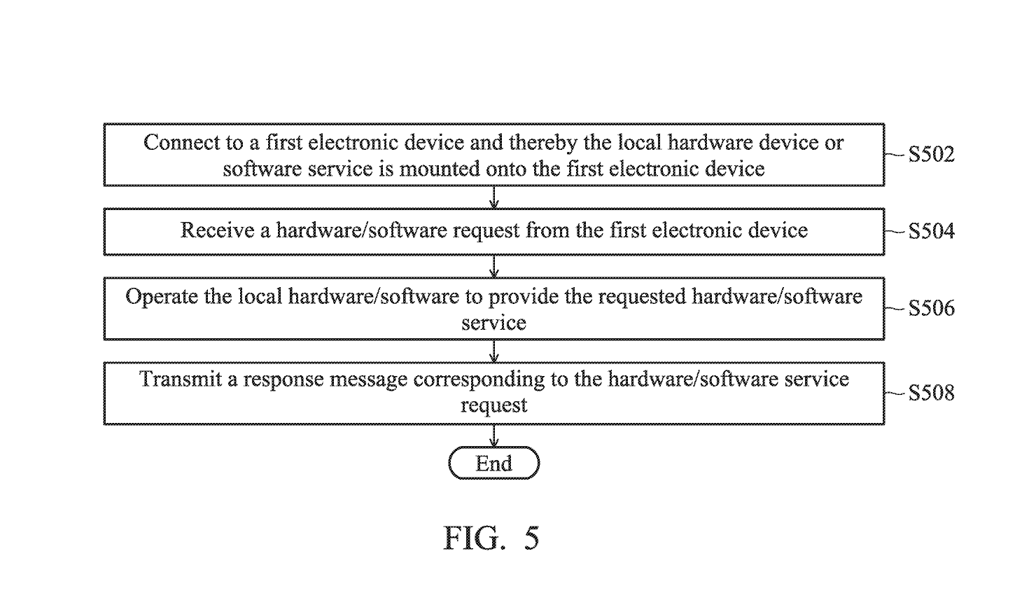

FIG. 5 is a flowchart depicting a method for providing hardware/software service, which is applied in the second electronic device 302 of FIG. 3. First, the connection module 332 establishes a connection to the first electronic device 300 through CrossMount™ and thereby at least one hardware module or software service of the second electronic device 302 is mounted onto the first electronic device 300 (in step S502). Second, the second electronic device 302 receives hardware/software service request from the first electronic device 300 (in step S504). When requesting a software service from the second electronic device 302, the request for the software service is transmitted to the transceiver modules 312. When requesting a hardware function of the second electronic device 302, the request for the hardware function is transmitted to the virtualization module 342. Then, the virtualization module 342 transmits the hardware or software service request to the processing module 322 (in step S506). The processing module 322 runs the service module 352 to provide the first electronic device 300 with the requested hardware/software service (in step S508), and further generates a response message indicating that the second electronic device 302 provides the requested hardware/software service. The response message is output to the first electronic device 300 (in step S508).

In an exemplary embodiment, the first electronic device 300 may be a smartphone, and the second electronic device may be a Wi-Fi speaker. The smartphone and the Wi-Fi speaker may be connected to each other and the hardware device, e.g. a high-quality speaker, of the Wi-Fi speaker may be successfully mounted onto the smartphone. When the smartphone detects that it does not itself include a high-quality speaker and needs to use the hardware of the Wi-Fi speaker to play audio and the smartphone itself is executing an application of cloud music sharing, a hardware/software service request asking for the hardware of another device (e.g. requesting the high-quality speaker) may be transmitted to the Wi-Fi speaker, and the Wi-Fi speaker provides the smartphone with the speaker function in response to the hardware/software service request. Thus, the smartphone can use the hardware (i.e. the high-quality speaker) of the Wi-Fi speaker in the applications running on the smartphone and operate the hardware of the Wi-Fi speaker accordingly. In this example, the smartphone may further execute an application to use the cloud music-sharing service on the Wi-Fi speaker and there is no need to install the associated application in the smartphone. For simplicity, the details of the exemplary embodiment are not redundantly repeated.

In other exemplary embodiments, the first electronic device and the second electronic device may be hardware devices like a tablet PC, an intelligent TV or a camera and so on, which may request or provide different hardware or software service. The detailed flowchart for implementation can be found in the aforementioned methods for requesting or providing hardware or software service.

In some exemplary embodiments, an electronic device may be connected to multiple electronic devices and requests for requesting the hardware/software service of the multiple connected electronic devices simultaneously or provides the same or different hardware/software service to the multiple connected electronic devices.

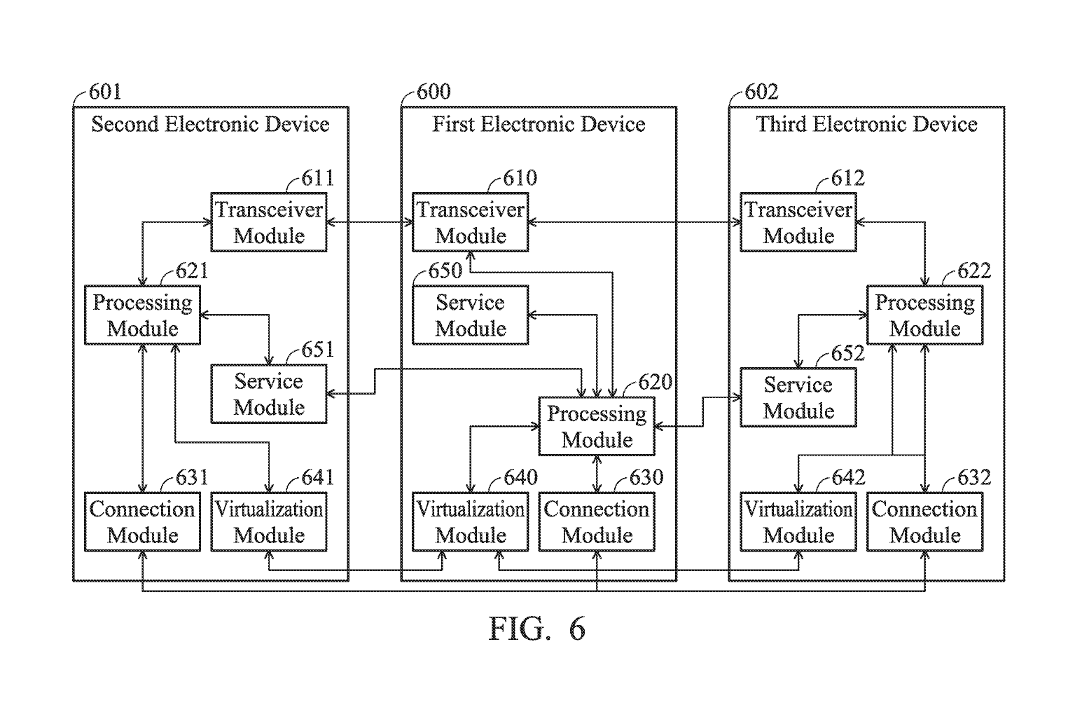

FIG. 6 depicts system architecture in which multiple electronic devices request hardware/software service of one electronic device. As shown in FIG. 6, the modules of the first electronic device 600, the second electronic device 601 and the third electronic device 602 are similar to that shown in the electronic devices 300 and 302 of FIG. 3 and detailed description is not redundantly repeated herein. The modules of the first electronic device 600 and the second electronic device 601 and the third electronic device 602 of FIG. 6 are for the purpose of the description of the exemplary embodiments of the disclosure, and are not intended to limit the present invention. The first electronic device 600 and the second electronic device 601 and the third electronic device 602 may further comprise other modules or components not shown in the figure.

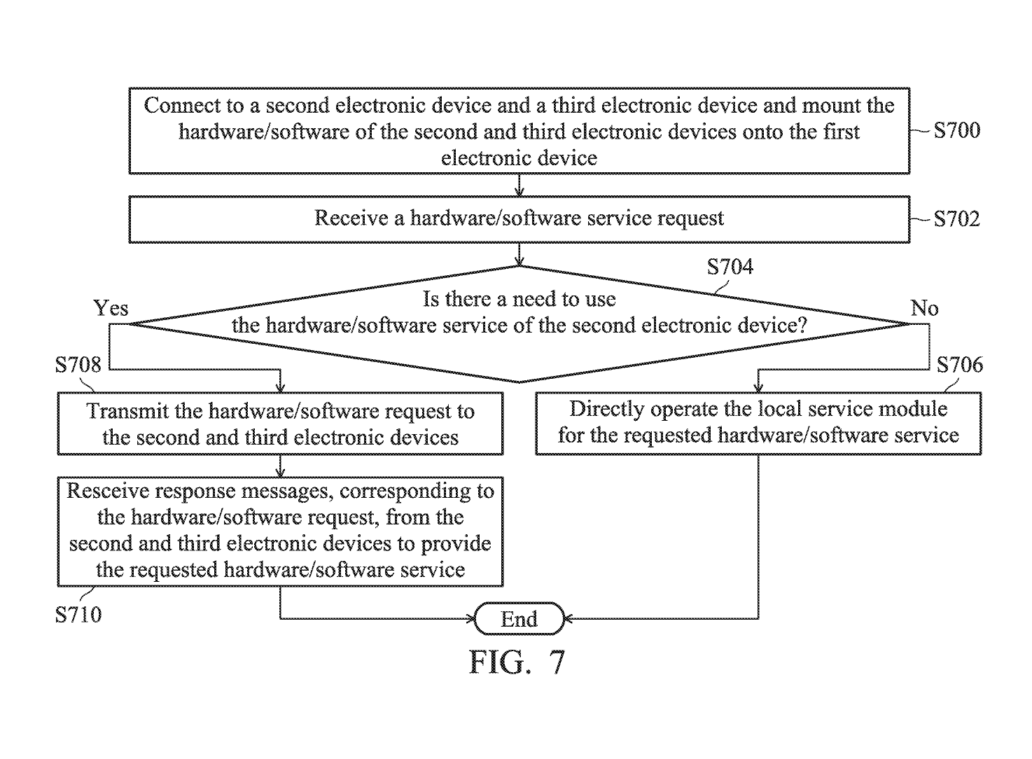

FIG. 7 is a flowchart depicting a method for requesting hardware/software service according to an exemplary embodiment of the disclosure, which is applied in the first electronic device 600 of FIG. 6. First, the the first electronic device 600is connected to the second electronic device 601 and the third electronic device 602 by CrossMount™, and at least one hardware module or software service of the second electronic device 601 and the third electronic device 602 are mounted onto the first electronic device 600 (in step S700). Second, the first electronic device 600 receives a hardware/software service request (in step S702) that may be transmitted from an electronic device (e.g. the second electronic device 601 or any other electronic device). Then, the processing module 620 determines whether there is a need to use the hardware/software of the second electronic device 601 and the third electronic device 602 (in step S704). When the processing module 620 determines that the service module 650 includes the hardware/software capable of providing the requested service, there is no need to use the hardware/software service module of other electronic devices. Therefore, the processing module 620 directly controls the service module 650 to run the requested hardware/software service (in step S706). When the first electronic device 600 does not include the requested hardware or software or the requested hardware or software in the first electronic device 600 is not available, it is determined that there is a need to use the the second electronic device 601 and the third electronic device 602, and the hardware/software service request is then transmitted to the second electronic device 601 and the third electronic device 602 by the virtualization module 640 to use the hardware/software modules of the second electronic device 601 and the third electronic device 602 to provide the requested hardware/software service (in step S708). Finally, the first electronic device 600 receives response messages from service provided by the second electronic device 601 and the third electronic device 602. The response messages indicate that the second electronic device 601 and the third electronic device 602 provide the requested hardware/software service (in step S710). In this manner, the hardware capability or software service of the second electronic device 601 and the third electronic device 602 is shared with the first electronic device 600. On the other hand, the second electronic device 601 and the third electronic device 602 output messages to the first electronic device 600 to indicate that the hardware/software service on the second and the third electronic devices 601 and 602 can be shared with the first electronic device 600. The associated architecture and process procedure are similar to the exemplary embodiment of FIG. 5 and detailed description is not redundantly repeated herein. The first electronic device 600 may output requests to all the mounted electronic devices at the same time. In another exemplary embodiment, the first electronic device 600 outputs a request to the second electronic device 601 firstly and, when it is determined that the hardware/software resource of the second electronic device 601 is insufficient, the first electronic device 600 further outputs a request to the third electronic device 602. The requests issued from the first electronic device 600 may be identical or different.

On the other hand, the method for providing service and applied in the second electronic device 601 and the third electronic device 602 can be understood according to the flowchart of FIG. 5 and detailed description is not redundantly repeated herein.

In an exemplary embodiment, multiple smartphones are interconnected with a screen or an intelligent TV for monitor display. According to the aforementioned method for requesting hardware/software service, an intelligent TV may successfully have hardware devices (e.g. cameras) of two or more smartphones mounted thereon. If necessary, the intelligent TV may request the hardware/software functions (e.g. camera functions) of the two or more smartphones. Not limited to the aforementioned examples, the present invention may be realized in many applications in daily life. In some exemplary embodiments, for families with young baby or bedridden elderly or even pets or plants requiring more attention or for home door security, any unused device with image capturing hardware, like smartphones, tablet PCs, PCs, NBs, cameras or surveillance cameras, may be used in real-time surveillance about the target object. In this manner, the surveillance pictures of the target object may be displayed on a smartphone, a tablet PC, a PC, a TV of the supervisor.

Devices with mounting connection according to the network proposal (e.g. CrossMount^{TM}) may be used in enabling one electronic device to serve another electronic device, or to serve multiple other electronic devices. Multiple electronic devices may output service requests to one specific electronic device separately, and the different service requests may be transmitted at the same time or in a sequential order.

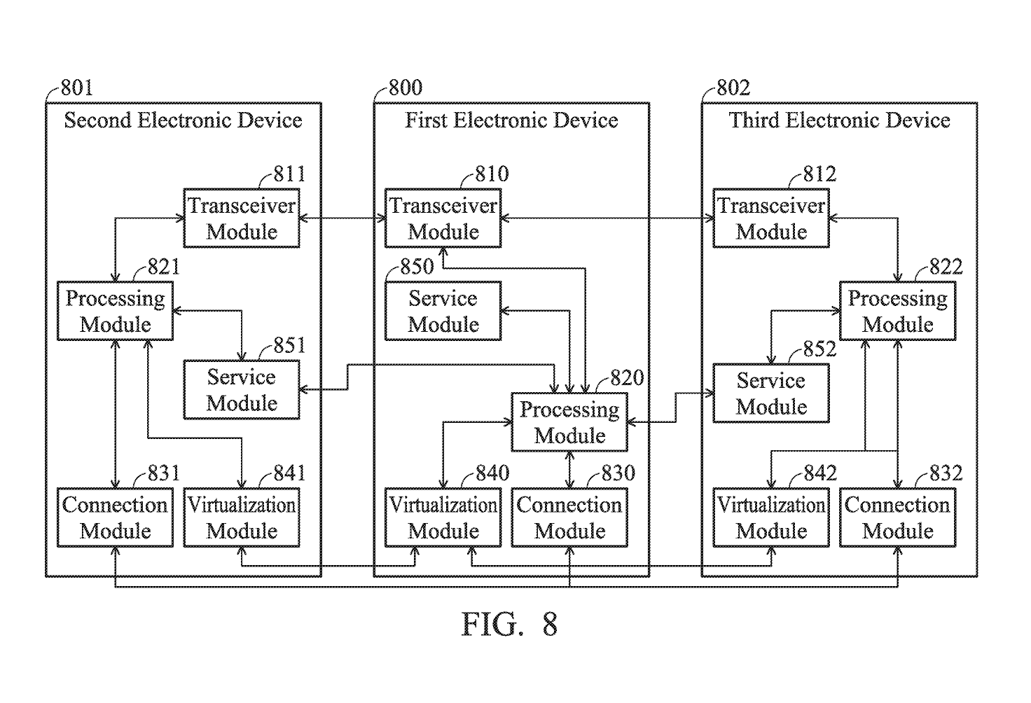

FIG. 8 depicts a system architecture in which one electronic device provides hardware/software service to multiple electronic devices in accordance with an exemplary embodiment of the disclosure. As shown in FIG. 8, the modules of the first electronic device 800, the second electronic device 801 and the third electronic device 802 are similar to those of the first electronic device 600, the second electronic device 601 and the third electronic device 602 of FIG. 6 and detailed description is not redundantly repeated herein. The modules of the first electronic device 800 and the second electronic device 801 and the third electronic device 802 of FIG. 8 are for the purpose of description of the exemplary embodiments of the disclosure, and are not intended to limit the present invention. The electronic devices may further comprise other modules or components not shown in the figure.

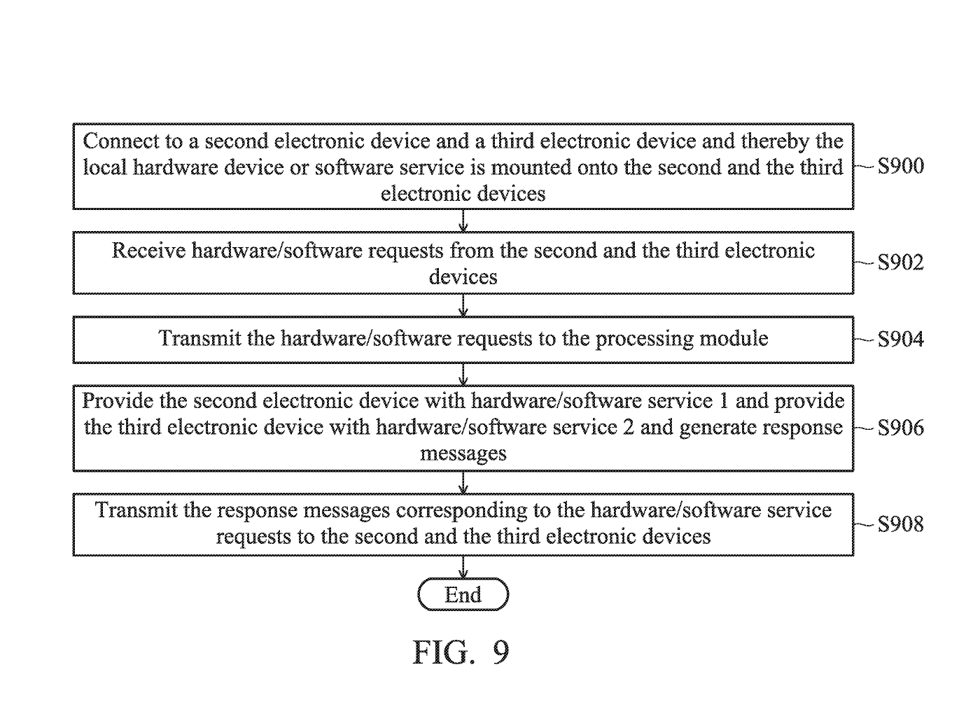

FIG. 9 is a flowchart depicting a method for providing hardware/software service in accordance with an exemplary embodiment of the disclosure, which is applied in a first electronic device 800. First, the first electronic device 800 is connected to the second electronic device 801 and the third electronic device 802 through network connection (e.g. by CrossMount™) and at least one hardware module or software service of the first electronic device 800 are mounted onto the second electronic device 801 and the third electronic device 802 (in step S900). Then, in step S902, the virtualization module 840 of the first electronic device 800 receives a hardware/software service request 1 from the second electronic device 801 and a hardware/software service request 2 from the third electronic device 802. Then, the virtualization module 840 transmits the hardware or software service requests to the processing module 820 separately (in step S904). The processing module 820 controls the service module 850 to provide the second electronic device 801 with the requested hardware/software service 1 and to provide the third electronic device 802 with the requested hardware/software service 2 and the processing module 820 further generates response messages (in step S906) indicating that the first electronic device 800 is providing the requested service. The response messages are transmitted to the second electronic device 801 and the third electronic device 802 (in step S908).

In this manner, the hardware capability and software service of the first electronic device 800 is further shared with the second electronic device 801 and the third electronic device 802. The second electronic device 801 and the third electronic device 802 may separately output requests to the first electronic device 800. The associated process procedure performed on the second electronic device 801 and the third electronic device 802 can be found in FIG. 4 and is not redundantly repeated herein.

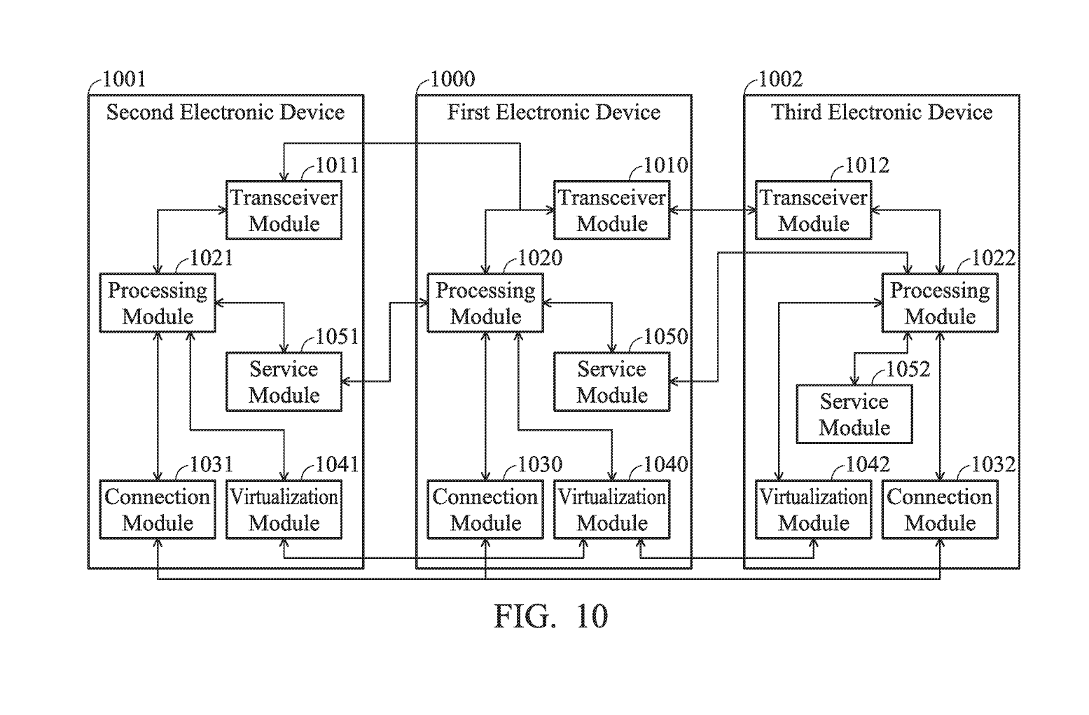

An electronic device may not be limited to a particular role. An electronic device may be a service provider and also send requests for service at the same time. The electronic device may provide service and request service at the same time. FIG. 10 illustrates system architecture of an exemplary embodiment of the disclosure. In FIG. 10, the first electronic device 1000 outputs a request to the second electronic device 1101 and receives another service request from the third electronic device 1002. With respect to the second electronic device 1001, the first electronic device 1000 is a device requesting service. On the other hand, the first electronic device 1000 is a service provider with respect to the third electronic device 1002. As shown in FIG. 10, the modules of the first electronic device 1000, the second electronic device 1001 and the third electronic device 1002 are similar to the electronic devices 300 and 302 of FIG. 3 and detailed description is not redundantly repeated herein. The connection module 1030 of the first electronic device 1000 is connected to the second electronic device 1001 and the third electronic device 1002 according to a network proposal (e.g. CrossMount™). The first electronic device 1000 may output a request to the second electronic device 1001 and receive a request from the third electronic device 1002. The requests may ask to use the hardware, software or service of the connected electronic device. The flowchart for the first electronic device 1000 to provide service and the flowchart for the first electronic device 1000 to request service can be found in FIG. 5 and FIG. 4, respectively, and detailed description is not redundantly repeated herein. It should be noted that the modules of the first electronic device 1000, the second electronic device 1001 and the third electronic device 1002 of FIG. 10 are for the description of the exemplary embodiments of the disclosure, and are not intended to limit the present invention. The first electronic device 1000, the second electronic device 1001 and the third electronic device 1002 may further comprise other hardware or software modules not shown in the figure. Hardware, software and service of interconnected electronic devices are conveniently shared between the interconnected electronic devices by the aforementioned hardware/software service processing methods.

Operations and functions of the various components and modules described herein can be implemented by hardware modules and embedded software codes. The embedded software codes may be accessed and executed by a processing module.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for processing hardware or software service requests, applied in a first electronic device, comprising:
receiving a first hardware or software service request;
determining whether there is a need to use hardware or software of a second electronic device to process the first hardware or software service request;
transmitting the first hardware or software service request to the second electronic device when there is a need to use hardware or software of the second electronic device;
receiving a first response message from the second electronic device, wherein the first response message indicates that the hardware or software of the second electronic device provides the first hardware or software service; and
providing the first hardware or software service according to the first response message,
wherein:
the first electronic device and the second electronic device are connected through network interconnection; and
the first electronic device receives information about the hardware or software of the second electronic device to virtualize the hardware or software of the second electronic device in the first electronic device.

2. The method as claimed in claim 1, further comprising:
determining whether there is a need to use hardware or software of a third electronic device to process the first hardware or software service request;
transmitting the first hardware or software service request to the third electronic device when there is a need to use hardware or software of the third electronic device;
receiving a second response message from the third electronic device, wherein the second response message indicates that the hardware or software of the third electronic device provides the first hardware or software service; and
providing the second hardware or software service according to the first response message and the second response message,
wherein:
the first electronic device and the third electronic device are connected through network interconnection; and
the first electronic device receives information about the hardware or software of the third electronic device to virtualize the hardware or software of the third electronic device in the first electronic device.

3. The method as claimed in claim 2, providing the first hardware or software service by the first electronic device itself when there is no need to use the hardware and software of the second and the third electronic device.

4. The method as claimed in claim 2, further comprising receiving data related to the first hardware or software service from the second electronic device or the third electronic device.

5. The method as claimed in claim 1, further comprising:
receiving a second hardware or software service request from the second electronic device;
controlling the hardware or software of the first electronic device to provide the second hardware or software service and generating a third response message to indicate that the first electronic device provides the second hardware or software service; and
transmitting the third response message to the second electronic.

6. The method as claimed in claim 5, further comprising providing data related to the second hardware or software service to the second electronic device.

7. The method as claimed in claim 5, wherein the first hardware or software service request or the second hardware or software service request is a request for camera, speaker or screen or a request for software application service.

8. The method as claimed in claim 2, wherein the first electronic device, the second electronic device or the third electronic device is a smartphone, a tablet PC, an intelligent TV or an audio set.

9. A method for processing hardware or software service requests, applied in a first electronic device, comprising:
receiving a first hardware or software service request from a second electronic device;
providing the first hardware or software service and generating a first response message to indicate that hardware or software of the first electronic device provides the first hardware or software service; and
transmitting the first response message to the second electronic device,
wherein:
the first electronic device and the second electronic device are connected to each other through network interconnection; and
the second electronic device receives information about the hardware or software of the first electronic device to virtualize the hardware or software of the first electronic device in the second electronic device.

10. The method as claimed in claim 9, further comprising transmitting data related to the first hardware or software service to the second electronic device.

11. The method as claimed in claim 9, wherein the first hardware or software service request is a request for camera, speaker or screen or a request for software application service.

12. The method as claimed in claim 9, wherein the first electronic device or the second electronic device is a smartphone, a tablet PC, an intelligent TV or an audio set.

13. An electronic device applied for requesting hardware or software service, comprising:
a connection module, establishing a connection to a second electronic device through network interconnection;
a processing module, coupled to the connection module, wherein when the electronic device receives a first hardware or software service request, the processing module determining whether there is a need to use hardware or software of a second electronic device to process the first hardware or software service request;
an virtualization module, coupled to the processing module, receiving information about the hardware or software of the second electronic device to virtualize the hardware or software of the second electronic device in the first electronic device, transmitting the first hardware or software service request to the second electronic device when there is a need to use the hardware or software of the second electronic device; and receiving a first response message from the second electronic device, wherein the first response message indicates that the hardware or software of the second electronic device provides the first hardware or software service; and
wherein the processing module further provides the first hardware or software service according to the first response message.

14. The electronic device as claimed in claim 13, wherein:
the connection module further establishes a connection to a third electronic device through network interconnection;
the processing module further determines whether there is a need to use hardware or software of the third electronic device to process the first hardware or software service request; and
the virtualization module further receives information about the hardware or software of the third electronic device to virtualize the hardware or software of the third electronic device in the first electronic device,
wherein:
when there is a need to use the hardware or software of the third electronic device, the virtualization module transmits the first hardware or software service request to the third electronic device;
the virtualization module receives a second response message from the third electronic device, wherein the second response message indicates that the hardware or software of the third electronic device provides the first hardware or software service; and
the processing module provides the first hardware or software service according to the first response message and the second response message.

15. The electronic device as claimed in claim 14, further comprising:
a service module, including hardware or software,
wherein the processing module controls the service module to provide the first hardware or software service when there is no need to use the hardware and software of the second and the third electronic device.

16. The electronic device as claimed in claim 14, further comprising:
a transceiver module, receiving data related to the first hardware or software service from the second electronic device or the third electronic device.

17. The electronic device as claimed in claim 13, further comprising:
a service module, including hardware or software,
wherein:
the virtualization module receives a second hardware or software service request from the second electronic device;
the virtualization module transmits the second hardware or software service request to the processing module; and
the processing module controls the service module to provide the second hardware or software service and generates a third response message to indicate that the hardware or software of the service module provides the second hardware or software service;
the virtualization module transmits the third response message to the second electronic device.

18. The electronic device as claimed in claim 17, further comprising:
a transceiver module, transmitting data related to the service corresponding to the second hardware or software service request to the second electronic device.

19. The electronic device as claimed in claim 17, wherein the first hardware or software service request or the second hardware or software service request is a request for camera, speaker or screen or a request for software application service.

20. The electronic device as claimed in claim 14, wherein the first electronic device, the second electronic device or the third electronic device is a smartphone, a tablet PC, an intelligent TV or an audio set.

21. An electronic device applied for providing hardware or software service, comprising:
a connection module, establishing a connection to a second electronic device through network interconnection;
an virtualization module, receiving a first hardware or software service request from the second electronic device;
a service module, including hardware or software to provide the first hardware or software service; and
a processing module coupled to the virtualization module, wherein according to the first hardware or software service request, the processing module controls the service module to provide the first hardware or software service and generates a first response message to indicate that the hardware or software of the first electronic device provides the first hardware or software service,
wherein the virtualization module transmits the first response message to the second electronic device.

22. The electronic device as claimed in claim 21, further comprising:
a transceiver module, transmitting data related to the first hardware or software service to the second electronic device.

23. The electronic device as claimed in claim 21, wherein the first hardware or software service request is a request for camera, speaker or screen or a request for software application service.

24. The method as claimed in claim 21, wherein the first electronic device or the second electronic device is a smartphone, a tablet PC, an intelligent TV or an audio set.
